(19) United States
(12) Patent Application Publication
(10) Pub. No.: US 2016/0247178 A1
(43) Pub. Date: Aug. 25, 2016

(54) METHODS AND SYSTEMS FOR SHARING COMPUTATIONAL RESOURCES

(71) Applicant: XEROX CORPORATION, Norwalk, CT (US)

(72) Inventors: Sujit Gujar, Pune (IN); Tridib Mukherjee, Bangalore (IN); Shruti Kunde, Mumbai (IN)

(21) Appl. No.: 14/629,510

(22) Filed: Feb. 24, 2015

(51) Int. Cl. G06Q 30/02; H04L 12/24; H04L 29/08; H04L 12/911

(52) U.S. Cl. CPC G06Q 30/0208; H04L 47/828; H04L 41/5003; H04L 41/5019; H04L 67/10

(57) ABSTRACT

Methods and systems for determining incentives for sharing one or more computational resources in a network. A request from a resource requester is received for executing a workload. The request comprises a service level agreement (SLA) associated with said execution of said workload. A contribution of one or more computational resources, associated with a resource provider, in satisfying said SLA is determined based at least on a capacity associated with said one or more computational resources, a duration of a usage of said one or more computational resources for said execution, and one or more constraints included in said SLA. The incentives for said resource provider for said sharing of said one or more computational resources is determined based at least on said contribution.

### TECHNICAL FIELD

The presently disclosed embodiments are related, in general, to a distributed computing environment. More particularly, the presently disclosed embodiments are related to methods and systems for determining incentives for sharing computational resources in the distributed computing environment.

### BACKGROUND

Distributed computing refers to a computing network in which one or more interconnected computing devices co-operate with each other by sharing one or more computational resources (e.g., instances of CPUs, RAM, disk-space, etc.). One of the types of distributed computing is volunteer computing in which resource providers can voluntarily share the computational resources for execution of a workload. For example, the resource providers can help certain applications/workloads that require high levels of processing power and memory usage by sharing these computational resources, when the computing devices associated with these resource providers are in an idle state.

In some scenarios, the resource providers may receive credit points for sharing the computational resources. Volunteer computing network such as BOINC has a credit system (e.g., a Cobblestone Credit System), which assigns points to the resource providers for sharing the computational resources. For example, if a computational resource is used for 24 hours and has a performance of 1 GIPS (Giga Instructions per Second), a resource provider may get 200 points for sharing the computational resources. Such points, given to the resource provider, are used by the system to assign rank to the resource providers. Based on the rank, the system may assign future tasks to the resource providers.

### SUMMARY

According to embodiments illustrated herein, there is provided a method for determining incentives for sharing one or more computational resources in a network. The method includes receiving a request from a resource requester for executing a workload. The request comprises a service level agreement (SLA) associated with said execution of said workload. The method further includes determining a contribution of one or more computational resources, associated with a resource provider, in satisfying said SLA, based at least on a capacity associated with said one or more computational resources, a duration of a usage of said one or more computational resources for said execution, and one or more constraints included in said SLA. The method further includes determining said incentives for said resource provider for said sharing of said one or more computational resources based at least on said contribution. The method is performed by one or more processors.

According to embodiments illustrated herein, there is provided a system for determining incentives for sharing one or more computational resources in a network. The system includes one or more processors operable to receive a request from a resource requester for executing a workload. The request comprises a service level agreement (SLA) associated with said execution of said workload. The one or more processors are further operable to determine a contribution of one or more computational resources, associated with a resource provider, in satisfying said SLA, based at least on a capacity associated with said one or more computational resources, a duration of a usage of said one or more computational resources for said execution, and one or more constraints included in said SLA. The one or more processors are further operable to determine said incentives for said resource provider for said sharing of said one or more computational resources based at least on said contribution.

According to embodiments illustrated herein, there is provided a computer program product for use with a computer. The computer program product includes a non-transitory computer readable medium. The non-transitory computer readable medium stores a computer program code for determining incentives for sharing one or more computational resources in a network. The computer program code is executable by one or more processors to receive a request from a resource requester for executing a workload. The request comprises a service level agreement (SLA) associated with said execution of said workload. The computer program code is further executable by the one or more processors to determine a contribution of one or more computational resources, associated with a resource provider, in satisfying said SLA, based at least on a capacity associated with said one or more computational resources, a duration of a usage of said one or more computational resources for said execution, and one or more constraints included in said SLA. The computer program code is further executable by the one or more processors to determine said incentives for said resource provider for said sharing of said one or more computational resources based at least on said contribution.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for sharing the one or more computational resources, in accordance with at least one embodiment;

FIG. 3 is a flowchart illustrating a method for sharing the one or more computational resources, in accordance with at least one embodiment; and

FIG. 4 is a flow diagram illustrating a method for sharing the one or more computational resources, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### DEFINITIONS

The following terms shall have, for the purposes of this application, the respective meanings set forth below.

A “computing device” refers to a device that includes a processor/microcontroller and/or any other electronic component, or a device or a system that performs one or more operations according to one or more programming instructions. Examples of the computing device include, but are not limited to, a desktop computer, a laptop, a personal digital assistant (PDA), a mobile phone, a smart-phone, a tablet computer, and the like. In an embodiment, the one or more computing devices may be utilized by one or more resource requesters and one or more resource providers.

“Computational resources” refer to one or more resources associated with the one or more computing devices, required for executing an application/workload. The computational resources may correspond to, but are not limited to, processor instances, memory, RAM space, CPUs, software applications, security services, and database services.

A “workload” refers to an application or software that the resource requesters may want to execute. The resource requesters may request for one or more computational resources from the distributed computing network for execution of the workload. The workloads may vary in their resource requirements; for example, some workloads may be memory-intensive (and thus may require large memory space to be executed), while other workloads may be CPU-intensive.

“Resource Requester” may refer to one or more computing devices that require one or more computational resources. In an embodiment, the resource requester may require the one or more computational resources to execute the workload. In another embodiment, the resource requester may transmit a request for the execution of the workload. In an embodiment, the request may include the workload to be processed or executed.

A “distributed computing network” refers to a computing network, in which one or more computing devices may share their respective computational resources for execution of the workload. In an embodiment, the workload may be provided by the resource requester. Hereinafter, the terms “distributed computing network”, “volunteer computing network”, and “computing network”, are used interchangeably.

“Resource Provider” may refer to one or more computing devices that may share the one or more computational resources with the one or more resource requesters. In an embodiment, the resource provider may receive incentives for sharing the one or more computational resources. In an embodiment, the resource provider may share one or more idle computational resources in the distributed computing network.

A “service level agreement (SLA)” refers to terms in a contract between the resource requesters and the resource providers. In an embodiment, the SLA may state the expectations agreed upon by the resource requesters and the resource providers for sharing the one or more computational resources. The SLA may include one or more constraints. For example, in an embodiment, the constraints included in the SLA may correspond to at least one of a required capacity of the one or more computational resources to execute the workload, a type of the one or more computational resources (e.g., small/medium/large VMs), a start time associated with a use of the one or more computational resources, an end time associated with a use of the one or more computational resources, or a cost associated with the one or more computational resources.

A “request” refers to a message that corresponds to a requirement of the one or more computational resources for execution of the workload. In an embodiment, the resource requester may transmit such request in the distributed computing network. In an embodiment, the request may include SLA (e.g., as disclosed above) associated with the execution of the workload.

“Incentives” refer to a remuneration received by the resource provider of a computing device for sharing the one or more computational resources. The one or more computational resources are utilized for the execution of applications/workloads. The incentives are received based on usage of the one or more computational resources. In an embodiment, the incentives may be monetary incentives received by the resource provider of the computing device. However, a person having ordinary skills in the art would understand that the scope of the disclosure is not limited to remunerating the resource provider with monetary incentives. In an embodiment, the resource provider may receive non-monetary incentives. The non-monetary incentives may include, but are not limited to, lottery tickets, gift items, shopping vouchers, and discount coupons. In an embodiment, the incentives may be provided to the resource provider based on a contribution of the one or more computational resources in satisfying the SLA (e.g., as disclosed above). In another embodiment, incentives may further correspond to strengthening of the relationship between the resource provider and the resource requester. For example, the resource requester may send more workloads for execution to the resource provider. In addition, a reputation score of the resource provider of the computing device may be improved so that more applications/workloads are directed to the resource provider for execution. A person skilled in the art would understand that combination of any of the above-mentioned means of incentives could be used for paying the resource provider.

A “required capacity” refers to a capacity required by the resource requester for execution of the workload. In an embodiment, the required capacity of the one or more computational resources is measured in Giga Instructions per second (GIPS). Further, the required capacity may further correspond to a time duration for which the one or more computational resources are required to execute the workload.

A “contribution of computational resources” refers to a measure of utilization of the one or more computational resources in execution of the workload according to the SLA associated with workload. In an embodiment, the contribution of the computational resources, associated with the resource provider, is determined based at least on a capacity of the one or more computational resources, a duration of usage of the one or more computational resources, and the SLA associated with the workload.

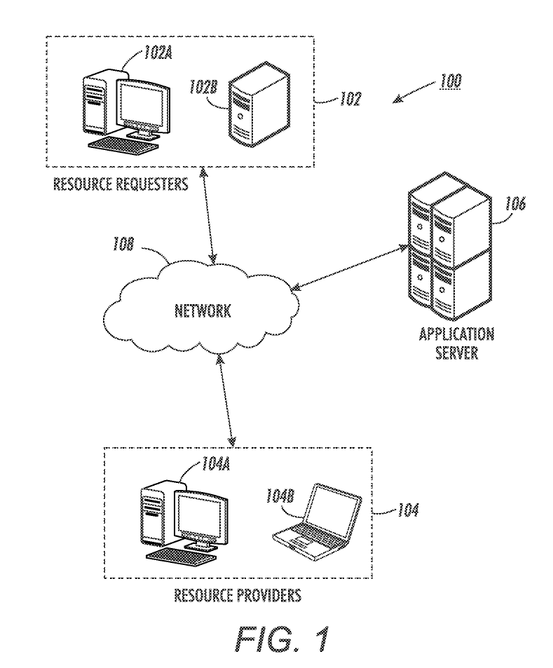

FIG. 1 is a block diagram illustrating a system environment 100 in which various embodiments can be implemented. The system environment 100 includes one or more computing devices 102a-b (hereinafter collectively referred to as resource requesters 102), one or more computing devices 104a-b (hereinafter collectively referred to as resource providers 104), and an application server 106. Various devices in the system environment 100 (e.g., the resource requesters 102, the resource providers 104, and the application server 106) may be interconnected over the network 108.

The resource requesters 102 may refer to one or more computing devices that may require one or more computational resources. In an embodiment, the resource requester (e.g., 102a) may not have enough computational resources to execute a workload or an application. In such a scenario, the resource requester 102a may generate the request for the one or more computational resources (e.g., to execute the application/workload). The resource requester 102a may transmit such requests to the application server 106. In an embodiment, the request may include an SLA associated with the execution of the workload. In an embodiment, the resource requester 102a may be realized through various computing devices, such as a desktop, a laptop, a personal digital assistant (PDA), a tablet computer, and the like.

It will be apparent to a person skilled in the art that the resource requester 102a may also receive one or more results of the one or more workloads associated with the one or more computational resources from the application server 106, without departing from the scope of the disclosure.

The resource providers 104 may refer to the one or more computing devices that may share the one or more computational resources for execution of the workload. In an embodiment, the resource provider (e.g., 104a) may monitor the one or more associated computational resources to check if the one or more associated computational resources are idle. If the one or more associated computational resources are idle, the resource provider 104a may share the idle resources for execution of the workload. In an embodiment, the resource provider 104a may transmit a message to the application server 106 comprising the list of idle computational resources and corresponding duration for which the one or more computational resources are available. Further, the message may include information pertaining to the duration for which the computational resources are available for sharing. The resource provider 104a may receive the workload from the application server 106 for execution. The resource provider 104a may provide the result of the execution to the application server 106. In an embodiment, the resource provider 104a may monitor the execution of the workload to determine the usage of the one or more computational resources (shared with the application server 106). In an embodiment, the resource provider 104a may transmit the usage information to the application server 106 along with the result. In an embodiment, the resource provider 104a may receive incentives for sharing the one or more computational resources based on a contribution. In an embodiment, the resource providers 104 may be realized through a variety of computing devices, such as a desktop, a laptop, a personal digital assistant (PDA), a tablet computer, and the like.

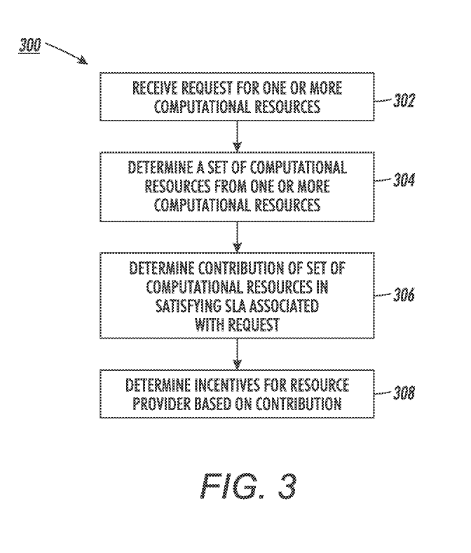

The application server 106 refers to a computing device that may receive request from the resource requester 102a for execution of the workload. Further, the application server 106 may receive information pertaining to the one or more computational resources from the resource provider 104a. In an embodiment, the one or more computational resources may correspond to the resource that may be used for executing the workload. The application server 106 may determine a set of computational resources from the one or more computational resources that may be used for executing the workload such that the SLA associated with the workload is not hampered. In an embodiment, while identifying the set of computational resources, the application server 106 may take into account a network latency associated with the one or more computational resources. Based on the usage of the set of computational resources, the application server 106 may provide incentives to the owners of the set of computational resources. The operation of the application server 106 has been described later in conjunction with FIG. 3. The application server 106 may be realized through various types of application servers such as, but not limited to, Microsoft® SQL server, Java application server, .NET framework, Base4, Oracle, and My SQL. In an embodiment, the application server 106 may correspond to a marketplace server.

The network 108 corresponds to a medium through which content and messages flow between various devices of the system environment 100 (e.g., the resource requesters 102, the resource providers 104 and the application server 106). Examples of the network 108 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2 G, 3 G, or 4 G communication protocols.

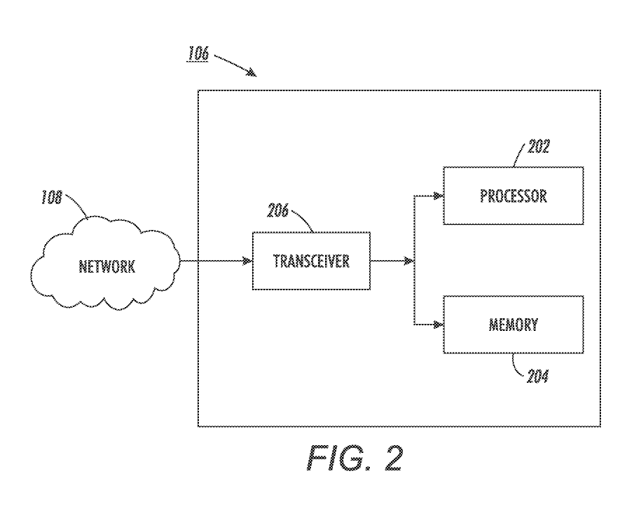

FIG. 2 is a block diagram illustrating the application server 106, in accordance with at least one embodiment. The application server 106 includes a processor 202, a memory 204, and a transceiver 206. The transceiver 206 is connected to the network 108.

The processor 202 is coupled to the memory 204 and the transceiver 206. The processor 202 includes suitable logic, circuitry, and/or interfaces that are operable to execute one or more instructions stored in the memory 204 to perform predetermined operation. The memory 204 may be operable to store the one or more instructions. The processor 202 may be implemented using one or more processor technologies known in the art. Examples of the processor 202 include, but are not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It will be apparent to a person having ordinary skills in the art that the one or more instructions stored in the memory 204 enables the hardware of the application server 106 to perform the predetermined operation.

The transceiver 206 transmits and receives messages and data to/from various devices of the system environment 100. Examples of the transceiver 206 may include, but are not limited to, an antenna, an Ethernet port, a USB port or any other port that can be configured to receive and transmit data. The transceiver 206 transmits and receives data/messages in accordance with the various communication protocols, such as, TCP/IP, UDP, and 2 G, 3 G, or 4 G communication protocols.

FIG. 3 is a flowchart 300 illustrating a method for sharing the one or more computational resources, in accordance with at least one embodiment. For the purpose of ongoing disclosure, the method for determining incentives for sharing the one or more computational resources is implemented by the application server 106. The flowchart 300 is described in conjunction with FIG. 1 and FIG. 2.

At step 302, a request for the one or more computational resources is received. In an embodiment, the processor 202 may receive the request from the resource requester (e.g., 102a). In an embodiment, the resource requester 102a may not have enough computational power to execute a workload. In such a scenario, the resource requester 102a may generate a request for execution of the workload. In an embodiment, the resource requester 102a may transmit such request to the processor 202. In an embodiment, the request may include the application/workload to be processed and an SLA associated with the execution of the application/workload. In an embodiment, the SLA may include information pertaining to the required capacity of the one or more computational resources required to execute the application/workload (included in the request). Further, the SLA may include information about the type of the computational resources required to execute the application/workload. The type of the computational resources include the information about RAM, disk-space, and instances of CPUs. Other constraints included in the SLAs may include, but are not limited to, a start time of the processing of the workload that the resource requester 102a expects, an end time of the processing of the workload, a cost that the resource requester 102a is willing to pay for the processing of the workload. The cost associated with the computational resources indicates the monetary incentives that the resource requester 102a is willing to pay for using the one or more computational resources. In another embodiment, the cost may further include non-monetary incentives. The non-monetary incentives may include, but are not limited to, lottery tickets, gift items, shopping vouchers, and discount coupons. In addition, a reputation score of the resource provider 104a of the computing device may be improved so that more applications/workloads are directed to the resource provider 104a for the execution.

Table 1 provided below illustrates the SLA associated with the request:

TABLE 1
Illustration of the SLA associated with the request.

| | | Type of | | | |
|---|---|---|---|---|---|
| | Required | computational | | | |
| Request | Capacity | resources | Start time | End Time | Cost ($) |
| Request-1 | 100 GIPS | 2 CPUs, 2 GB | 06:00 AM | 08:00 AM | 0.5 |
| | | RAM, 40 GB | | | |
| | | disk-space | | | |
| Request-2 | 2 GIPS | 4 CPUs, 4 GB | 07:00 AM | 11:00 AM | 1.0 |
| | | memory, | | | |
| | | 40 GB | | | |
| | | disk-space | | | |
| Request-3 | 50 GIPS | 8 CPUs, 8 GB | 04:00 AM | 05:00 AM | 1.5 |
| | | memory, | | | |
| | | 500 GB | | | |
| | | disk-space | | | |

Referring to Table 1, “Request-1” requires 100GIPS capacity for satisfying the SLA. The cost that the resource requester 102a may wish to bear associated with the computational resource is $0.5. The start and the end time associated with the computational resource is 06:00 AM and 08:00 AM. For example, in another embodiment, the processor 202 receives a “Request-2” from the resource requester 102a, which requires 2GIPS capacity for satisfying the SLA. The cost associated with the computational resource is $1. The start and end time associated with the computational resource is 07:00 AM and 11:00 AM. Thus, the processor 202 can perform the execution of the workload based on the required capacity of the one or more computational resources associated with the request in satisfying the SLA.

It will be apparent to a person having ordinary skill in the art that the above Table 1 has been provided only for illustration purposes and should not limit the scope of the invention to these types of constraints of SLA only. For example, the constraints included in the SLA may be different from the depicted requirements and may include more or less requirements than depicted in the Table 1.

In an embodiment, the required capacity of the computational resource may be determined based on one or more known benchmarking techniques such as whetstone benchmarking. In an embodiment, the resource requester 102a may provide the information pertaining to the required capacity. In a scenario, where the resource requester 102a does not provide such information, the processor 202 may determine the required capacity of the computational resources using the benchmarking techniques.

At step 304, a set of computational resources are determined from the one or more computational resources. In an embodiment, the processor 202 may determine the set of computational resources. The set of computational resources may process the request (or workload) received from the resource requester 102a.

Prior to determining the set of computational resources, the processor 202 may receive information pertaining to the one or more computational resources from the resource provider 104a. In an embodiment, the information pertaining to the one or more computational resources include type of computational resources available, a duration for which the computational resources are available, and a network latency between the application server 106 and the resource provider 104a.

Table 2 illustrates the information pertaining to the one or more computational resources received from the resource provider 104a:

TABLE 2
Illustration of the information pertaining to the one or more
computational resources received from the resource provider.

| | Duration | | | | |
|---|---|---|---|---|---|
| | for | | | | |
| | which | | | | |
| | Compu- | | | | |
| | tational | | | | |
| | Resource | | | | |
| Compu- | is | Network | | | Type of |
| tational | available | Bandwidth | Cost | | computational |
| Resources | (hours) | (Mbps) | ($) | Capacity | resources |
| Resource-1 | 2 | 8 | 1.5 | 2 GIPS | 2 CPUs, 2 GB |
| | | | | | RAM, 40 GB |
| | | | | | disk-space |
| Resource-2 | 0.5 | 2 | 0.5 | 80 GIPS | 4 CPUs, 4 GB |
| | | | | | memory, |
| | | | | | 40 GB |
| | | | | | disk-space |
| Resource-3 | 1 | 10 | 1.0 | 120 GIPS | 8 CPUs, 8 GB |
| | | | | | memory, |
| | | | | | 500 GB |
| | | | | | disk-space |

It can be observed from the Table 2 that “Resource-1” has capacity of 2GIPS. The computational resource “Resource-1” is available for two hours. It means the “Resource-1” is available for two hours for execution of the workload. The cost associated with the “Resource-1” is $1.5. For example, in another embodiment, the processor 202 receives a “Resource-2” from the resource provider 104a, which has capacity of 80GIPS. The computational resource “Resource-2” is available for 0.5 hours. The cost associated with the “Resource-2” is $0.5. Thus, the processor 202 performs the execution of the workload based on the information pertaining to the one or more computational resources received from the resource provider 104a.

In an embodiment, the processor 202 may select the set of computational resources based on the capacity requirement of the request received from the resource requester 102a and the capacity of the one or more computational resources. For example, referring to the Table 1, the “Request-2” requires a capacity of 2GIPS for a duration of 0.5 hours. Similarly, the “Request-3” requires a capacity of 50GIPS for a duration of one hour. Further, referring to Table 2, the “Resource-1” is available for two hours and has the capacity of 2GIPS. Further, the “Resource-2” is available for 0.5 hours and has the capacity of 80GIPS. Thereafter, the processor 202 may select the computational resource, “Resource-1” for execution of the workload based on the request received from the resource requester 102a.

In an embodiment, the processor 202 may employ matching algorithms to determine the set of the computational resources for the “Request-1” and “Request-2”. For instance, the processor 202 may select the “Resource-1” for the “Request-1”. As the “Resource-1” has double the capacity required by the “Request-1”, the time for which it may be allocated for the “Request-1” may be halved. Similarly, for the “Request-2”, the “Resource-2” and the “Resource-3” can be assigned to process the “Request-2”. In such a scenario, the “Request-2” may be divided into two parts out which a first part is sent to the “Resource-2” and a second part is sent to the “Resource-1”. Post receiving the information, the processor 202 identifies the set of computational resources that may be best suited to execute the workload.

A person having ordinary skill in the art would understand that the resource requester 102a may not provide information pertaining to the capacity of the one or more computational resources. In such a scenario, the processor 202 may determine a capacity of each of the one or more computational resources based at least on the computing power of the one or more computational resources, the duration for which the one or more computational resources are available, and the network bandwidth between the resource requester 102a and the resource provider 104a. It will be apparent to a person having ordinary skill in the art that combination of any of the above-mentioned means could be used to determine the capacity of each of the one or more computational resources.

In an embodiment, the processor 202 may assign weightage (i.e., α,β) corresponding to each of the computing power of the one or more computational resources and the network bandwidth, respectively. The processor 202 may determine the weightage (i.e., α,β) based on an amount of data transfer between the resource requester 102a and the resource provider 104a. In an alternate embodiment, the processor 202 may receive an input from the resource requester 102a on the weightage of the network bandwidth and the computing power. Let α correspond to a weight assigned to the computing power of the one or more computational resources. In an embodiment, the value of α lies in between 0 and 1. Based on the value of α, the processor 202 may determine the value of β (weight assigned to the network bandwidth). In an embodiment, the processor 202 may utilize below equation to determine the weight assigned to the network bandwidth, β based on the value of α:

β=α−1 (1)

where,

α,β=Weightage corresponding to the computing power and the network bandwidth of the one or more computational resources.

Thereafter, the processor 202 may transmit a benchmarking task to the computational resources at time tₛ and may receive the output of the benchmarking task at time tₑ. Let t be the time taken by the computational resource to execute the benchmarking task. The processor 202 may utilize the following equation to determine the capacity of the one or more computational resources:

$$c = α \frac{b}{{t}_{e} - {t}_{s} - t} + β \frac{X}{t} \qquad ( 2 )$$

where,

c=Capacity of the one or more computational resources measured in GIPS (Giga Instructions per second);

tₛ=Start Time, at which the processor transmits the benchmarking task to computational resources;

tₑ=End Time, at which the processor receives the output of the benchmarking task;

X=Number of instructions required to execute the benchmarking task;

t=Time taken by the computational resource to execute the benchmarking task;

b=Number of megabytes;

α,β=Weightage corresponding to the computing power and the network bandwidth of the one or more computational resources.

A person having ordinary skill in the art would understand that sending the benchmarking task to the one or more computational resources refer to the benchmarking task being sent to the respective resource provider 104a.

In another embodiment, the processor 202 may determine the capacity of the one or more computational resources based on the duration for which the one or more computational resources are available. In an embodiment, if the processor 202 determines that the benchmarking task requires X Giga instructions to execute in a time t seconds, the processor 202 may utilize the below equation:

$$c = \frac{X}{{t}_{e} - {t}_{s}} \qquad ( 3 )$$

where,

c=Capacity of the one or more computational resources measured in GIPS (Giga Instructions per second);

tₛ=Start Time, at which the processor transmits benchmarking task to computational resources;

tₑ=End time, at which the processor receives the output of the benchmarking task;

X=Number of instructions required to execute the benchmarking task.

Post determining the capacity of one or more computational resources, the processor 202 may select the set of computational resources from the one or more computational resources.

At step 306, the contribution of the set of computational resources is determined. The processor 202 may determine the contribution of the set of computational resources associated with the resource provider 104a. The contribution of the set of computational resources is determined based on the capacity associated with the one or more computational resources, as discussed in the step 304. Prior to determining the contribution, the processor 202 transmits the workload to the set of computational resources. If there is a need to segregate the workload, the processor 202 may employ one or more known techniques to segregate the workload.

In an embodiment, the processor 202 may determine the request efficiency (ρ) based on the capacity of the one or more computational resources and the required capacity of the one or more computational resources (mentioned in the request). In an embodiment, the processor 202 may utilize the following equation to determine the request efficiency:

$$ρ = \frac{c}{r} \qquad ( 4 )$$

where,

ρ=Request Efficiency parameter;

c=Capacity of the one or more computational resources;

r=Required Capacity of the one or more computational resources.

For example, the request requires 2GIPS capacity for the execution of the workload for two hours. The processor 202 may determine that the two computational resources having capacities of 1.5 GIPS and 1 GIPS are available. Therefore, the processor 202 may segregate the workload in two parts. The first part is sent to the first computational resource (having capacity of 1.5 GIPS) and the second part is sent to the second computational resource (having capacity of 0.5GIPS). The processor 202 further determines the request efficiency based on the required capacity and the capacity of the two computational resources. Thus, the request efficiency for the first computational resource is 0.75 (by utilizing the equation 4) and the request efficiency of the second computational resource is 0.5 (by utilizing the equation 4).

Further, in an embodiment, the processor 202 may determine weighing factor. The weighing factor is determined based on value of the request efficiency. In an embodiment, the processor 202 may utilize the below equation to determine the weighing factor:

$$W = {ρ}^{\frac{1}{n}} \\ If ρ \leq 1 = {log}_{10} ( 9 + ρ ) otherwise \qquad ( 5 )$$

where,

w=Weighing factor;

ρ=Request Efficiency;

n=Ratio of weighing factor and request efficiency parameter.

In an embodiment, the processor 202 may utilize the weighing factor to determine incentives for the resource provider 104a for sharing the one or more computational resources. In an embodiment, the processor 202 may determine the contribution of the set of computational resources based at least on the duration of the usage of the set of the computational resources from the one or more computational resources for the execution of the workload, and the constraints included in the SLA, as discussed above.

At step 308, the incentives for the resource provider 104a are determined. The processor 202 may determine the incentives for the resource provider 104a for sharing the one or more computational resources. The incentives are determined for the resource provider 104a based on the contribution of the set of computational resources. The contribution of the set of computational resources is determined based at least on the capacity associated with the one or more computational resources, the duration of the usage of the set of the computational resources from the one or more computational resources for the execution of the workload, the weighing factor associated with the set of computational resources, and the constraints included in the SLA, as discussed above.

Therefore, to determine the incentives for the resource provider 104a, the processor 202 may utilize the below equation:

Incentives=w·c·t·p (6)

where,

w=Weighing factor;

c=Capacity of the one or more computational resources;

t=Duration of usage of one or more computational resources measured in hours;

p=Cost per usage of the one or more computational resources.

For example, Table 3 provided below illustrates an example for determining incentives:

TABLE 3
Illustration of determining incentives for the resource provider

| | | Duration for | | |
|---|---|---|---|---|
| | | which | | |
| | Capacity of the | computational | | Incentives |
| | computational | resource is | | (cents) for |
| Computational | resources | available | Cost | the Resource |
| Resources | (GIPS) | (hours) | (cents) | provider |
| A | X GIPS | 1.2 | 1.5 | 5.046 |
| B | 0.5X GIPS | 2.4 | 0.5 | 8.484 |
| C | 0.8X GIPS | 1.5 | 1.0 | 1 |

It can be observed from the Table 3 that there are three computational resources A, B, and C. The capacity of A, B and C are X GIPS, 0.5X GIPS, and 0.8X GIPS. In order to satisfy the SLA associated with the execution of the workload, 2X GIPS of capacity is required for 2 hours, considering that the processor 202 may share the computational resources between A and B. Further, the computational resource A can be used for 1.2 hours and the computational resource B can be used for 2.4 hours. Based on the required capacity and the capacity of the two computational resources A and B, the processor 202 determines the request efficiency for the two computational resources A and B. Thus, the request efficiency for the computational resource A is 0.5 (by utilizing the equation 4), and the request efficiency for the computational resource B is 0.25 (by utilizing the equation 4).

Further, based on the values of the request efficiency for the two computational resources A and B, the processor 202 determines the weighing factor for the two computational resources, considering the value of n is four. The weighing factor for the computational resource A is 0.841 (by utilizing the equation 5). Similarly, the weighing factor for the computational resource B is 0.707 (by utilizing the equation 5).

Further, based on the determined values of the request efficiency and the weighing factor for the two computational resources A and B, the processor 202 determines incentives for A and B. Thus, the incentives for A is 1.5138 cents (by utilizing the equation 5), and similarly, the incentives for B is 0.8484 cents.

In an embodiment, the incentives may be monetary incentives received by the resource provider 104a of the computing device. In another embodiment, the incentives may be non-monetary incentives received by the resource provider 104a for sharing the computational resources. The non-monetary incentives may include, but are not limited to, discount coupons, shopping vouchers, gift items, or lottery tickets. In another embodiment, the non-monetary incentives for the resource provider 104a may include a usage of products/services offered by one or more third parties. For example, in an embodiment, the non-monetary incentives may be in the form of discount based on the usage of the products/services offered by the one or more third parties.

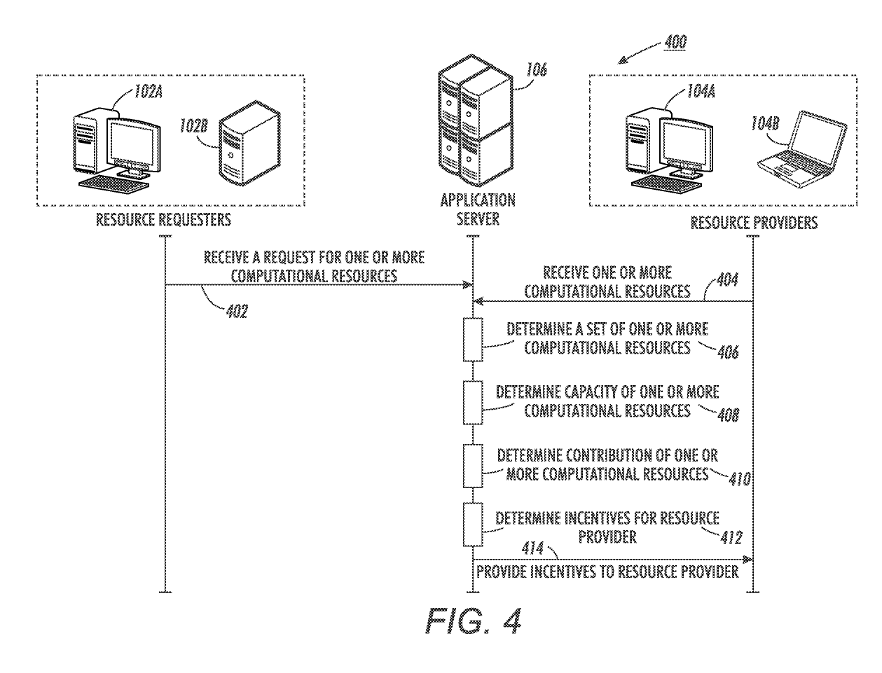

FIG. 4 is a flow diagram 400 illustrating a method for sharing the one or more computational resources, in accordance with at least one embodiment.

The processor 202 receives a request from the resource requester 102a (depicted by 402). The request may include the application/workload to be processed and an SLA associated with the execution of the application/workload, as discussed in the step 302. Subsequently, the processor 202 receives the one or more computational resources from the resource provider 104a (depicted by 404). The one or more computational resources may be utilized to serve the request received from the resource requester 102a. Further, the processor 202 determines the set of computational resources from the one or more computational resources (depicted by 406). The set of computational resources may process the request received from the resource requester 102a. Based on the received one or more computational resources, the processor 202 determines the capacity of the one or more computational resources (depicted by 408), as discussed in the step 304. The processor 202 further determines the contribution of the set of computational resources (depicted by 410) based on the capacity of the one or more computational resources, as discussed in the step 306. Based on the contribution of the set of computational resources, the processor 202 determines incentive for the resource provider 104a (depicted by 412), for sharing the computational resources, as discussed in the step 308. Further, the processor 202 provides incentive to the resource provider 104a for sharing the one or more computational resources (depicted by 414).

The disclosed embodiments encompass numerous advantages. Through various embodiments for methods and systems for determining incentives for sharing the computational resources, it is disclosed that the resource provider may receive incentives for sharing the computational resources. This kind of scenario may be helpful in achieving the SLA associated with the execution of the applications/workloads. Further, the disclosed method and system considers the network bandwidth that plays an important role in end-to-end computation time.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for determining incentives for sharing the computational resources in a distributed computing network have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for determining incentives for sharing one or more computational resources in a network, the method comprising:
receiving, by one or more processors, a request from a resource requester for executing a workload, wherein said request comprises a service level agreement (SLA) associated with said execution of said workload;
determining, by said one or more processors, a contribution of one or more computational resources, associated with a resource provider, in satisfying said SLA, based at least on a capacity associated with said one or more computational resources, a duration of a usage of said one or more computational resources for said execution, and one or more constraints included in said SLA; and
determining, by said one or more processors, said incentives for said resource provider for said sharing of said one or more computational resources based at least on said contribution.

2. The method of claim 1, wherein said capacity associated with said one or more computational resources is determined based at least on a computing power of said one or more computational resources, and a network bandwidth between said resource requester and said resource provider.

3. The method of claim 2 further comprising receiving, by said one or more processors, weightage corresponding to each of said computing power and said network bandwidth to determine said capacity.

4. The method of claim 1, wherein said one or more computational resources correspond to at least one of CPUs, memory, or disk-space.

5. The method of claim 1, wherein said incentives comprise at least one of monetary incentives and non-monetary incentives.

6. The method of claim 5, wherein said non-monetary incentives comprise at least one of a usage of products/services offered by one or more third parties, discount coupons, shopping vouchers, gift items, or lottery tickets.

7. The method of claim 1, wherein said network corresponds to a distributed computing network.

8. The method of claim 1, wherein said constraints included in said SLA comprise at least one of a required capacity of said one or more computational resources to execute said workload, a type of said one or more computational resources, a start time associated with a use of said one or more computational resources, an end time associated with a use of said one or more computational resources, or a cost associated with said one or more computational resources.

9. A system for determining incentives for sharing one or more computational resources in a network, the system comprising:
one or more processors operable to:
receive a request from a resource requester for executing a workload, wherein said request comprises a service level agreement (SLA) associated with said execution of said workload;
determine a contribution of one or more computational resources, associated with a resource provider, in satisfying said SLA, based at least on a capacity associated with said one or more computational resources, a duration of a usage of said one or more computational resources for said execution, and one or more constraints included in said SLA; and
determine said incentives for said resource provider for said sharing of said one or more computational resources based at least on said contribution.

10. The system of claim 9, wherein said capacity associated with said one or more computational resources is determined based at least on a computing power of said one or more computational resources, and a network bandwidth between said resource requester and said resource provider.

11. The system of claim 10, wherein said one or more processors are further operable to receive weightage corresponding to each of said computing power and said network bandwidth to determine said capacity.

12. The system of claim 9, wherein said one or more computational resources correspond to at least one of CPUs, memory, or disk-space.

13. The system of claim 9, wherein said incentives comprise at least one of monetary incentives and non-monetary incentives.

14. The system of claim 13, wherein said non-monetary incentives comprise at least one of a usage of products/services offered by one or more third parties, discount coupons, shopping vouchers, gift items, or lottery tickets.

15. The system of claim 9, wherein said network corresponds to a distributed computing network.

16. The system of claim 9, wherein said constraints included in said SLA comprise at least one of a required capacity of said one or more computational resources to execute said workload, a type of said one or more computational resources, a start time associated with a use of said one or more computational resources, an end time associated with a use of said one or more computational resources, or a cost associated with said one or more computational resources.

17. A computer program product for use with a computer, the computer program product comprising a non-transitory computer readable medium, wherein the non-transitory computer readable medium stores a computer program code for determining incentives for sharing one or more computational resources in a network, wherein the computer program code is executable by one or more processors to:
receive a request from a resource requester for executing a workload, wherein said request comprises a service level agreement (SLA) associated with said execution of said workload;
determine a contribution of one or more computational resources, associated with a resource provider, in satisfying said SLA, based at least on a capacity associated with said one or more computational resources, a duration of a usage of said one or more computational resources for said execution, and one or more constraints included in said SLA; and
determine said incentives for said resource provider for said sharing of said one or more computational resources based at least on said contribution.
